(19) United States
(12) Patent Application Publication
(10) Pub. No.: US 2007/0217424 A1
(43) Pub. Date: Sep. 20, 2007

(54) Apparatus and method for processing packets in secure communication system

(76) Inventors: Si-Baek Kim, Suwon-si (KR); Dae-Hyun Lee, Suwon-si (KR)

Correspondence Address: Robert E. Bushnell, Suite 300, 1522 K Street, N.W., Washington, DC, 20005, US

(21) Appl. No.: 11/724,274

(22) Filed: Mar. 15, 2007

(30) Foreign Application Priority Data
Mar. 17, 2006 (KR) 10-2006-0024711

(51) Int. Cl. H04L 12/56

(52) U.S. Cl. 370/392; 370/401

(57) ABSTRACT

A secure communication system comprises at least one virtual private network (VPN) gateway for managing tunnel information of other VPN gateways that are connected via tunnels for secure communication, and for transmitting the tunnel information to each terminal connected via a secure network. When a packet received from the terminal is destined for the secure network, the VPN gateway encrypts the packet, adds a tunnel header to the packet, and transmits the resultant packet to the corresponding tunnel. At least one terminal stores the tunnel information received from the gateways. When tunnel information identical to the destination address information of the generated packet is not stored, the terminal fragments the packet into a first set packet fragmentation size, and when tunnel information identical to the destination address information of the generated packet is stored, the terminal fragments the packet into a second packet fragmentation size, and transmits the fragmented packets to the VPN gateway connected to a corresponding secure network. The packet fragmentation size can be adjusted when the packet is changed in size according to the type of network, thereby preventing the number of packets on the network from increasing geometrically.

### CLAIM OF PRIORITY

This application makes reference to, incorporates the same herein, and claims all benefits accruing under 35 U.S.C.§ 119 from an application for APPARATUS AND METHOD FOR PROCESSING PACKETS IN SECURE COMMUNICATION SYSTEM earlier filed in the Korean Intellectual Property Office on the 17 Mar. 2006 and there duly assigned Serial No. 2006-24711.

### BACKGROUND OF THE INVENTION

1. Field of the Invention

The present invention relates to an apparatus and method for processing packets in a secure communication system.

2. Description of the Related Art

In a typical Internet protocol (IP) network, nodes such as terminals, routers, and the like determine the size of a maximum transmission unit (MTU) based on an interface type (e.g., Ethernet, and asynchronous transfer mode (ATM)) of a network connecting the nodes.

The terminal or node fragments a generated packet according to the determined size of the MTU and transmits the fragmented packets to the IP network. That is, the terminal or node fragments the packet in a prescribed manner in which the size of the MTU is determined according to the interface type of the connected network, and transmits the fragmented packet.

However, the size of the packet may be changed as contents of fields of the packet are modified according to the type of an application. For example, in the case of a session initiation protocol (SIP) message, which is a signaling packet of a voice over Internet protocol (VoIP), contents of a VIA header and a ROUTE header are, in an SIP server, added to or deleted from the packet transmitted from the terminal along a transmission path. That is, the packet size is not fixed.

A virtual private network (VPN) developed for IP security uses a technique of encrypting a packet transferred between nodes and transmitting the packet to an IP network using a tunneling scheme in order to prevent the packet from being maliciously intercepted and decrypted.

IP security (IPsec) for providing secure communication via a VPN has been developed. The IPsec provides secure communication services, such as confidentiality, data integrity, access control, and data source authentication.

To transmit a packet via the tunnel in the VPN, a VPN gateway encrypts the packet, adds a tunnel header before a front end of the packet, and transmits the resultant packet via a tunnel for secure communication.

In a tunnel mode VPN, the tunnel header added by the VPN gateway is about 70 bytes in length, including 20 bytes for a new IP header, 8 bytes for an ESP header, about 30 bytes for a variable padding field, 1 byte for a pad length field, 1 byte for a next header field of an ESP tail field, and about 10 bytes for a variable ESP authentication data field.

As described above, when a header or field is added to a packet which is fragmented according to the size of the MTU by the terminal or node in the course of transmission, e.g., when a header or field is added to the packet at a VPN gateway, the VPN gateway re-fragments the packet since the packet exceeds the size of the MTU due to the added header or field.

Typical packet fragmentation is optimized on the assumption that a packet larger than an MTU does not change in size in the course of transmission.

However, in secure communication such as an IPsec tunnel mode, if a packet changes in size due to addition of a tunnel header, it must be re-fragmented. This re-fragmentation geometrically increases the number of packets on a network and, in turn, increases network overhead, thus degrading use of the network.

For example, a packet larger than the MTU is divided into a first packet P_frag fragmented by the size of the MTU and a second packet P_last, i.e., a remaining packet. As a tunnel header is added to the first packet P_frag passing through a tunnel in a tunnel mode, the first packet P_frag is re-fragmented into a first packet P_frag of MTU size and a remaining packet P_frag_last.

In the terminal or node, a generated packet is fragmented according to the MTU size, and when the number of first packets P_frag obtained by the fragmentation is N, the total number of packets fragmented and transmitted by the terminal or node is P_frag+P_last, i.e., N+1. When the N+1 packets pass through the tunnel, the first packets P_frag are re-fragmented into 2N+1 packets. Thus, it can be seen that the number of packets transferred via the tunnel increases by geometric progression.

### SUMMARY OF THE INVENTION

It is an object of the present invention to provide an apparatus and method for processing packets in a secure communication system or VoIP system in which a packet fragmentation size is properly adjusted according to the type of network transmitting packets when the packets are changed in size, for example, so that the number of packets transmitted via the network in the secure communication system or VoIP system is prevented from increasing by geometric progression in comparison with the number of packets transmitted by a terminal or node.

A first aspect of the present invention provides a communication system including at least one terminal, the system comprising: a gateway for managing at least one destination address information of a packet to which a field of a set size is added, among destination address information of packets received from each terminal, and for transmitting the address information to each terminal, wherein when the destination address information of the packet received from each terminal exists in the managed address information, the gateway adds the field of the set size to the packet and transmits the resultant packet to a network; the at least one terminal storing the address information received from the gateway, fragmenting the packet into one of different set packet fragmentation sizes according to whether address information identical to the destination address information of the generated packet is stored, and transmitting the fragmented packets to the gateway.

The field of the set size may be a tunnel header required for the gateway to transmit the packet via a tunnel according to IPsec.

When address information identical to the destination address information of the generated packet is not stored, the packet fragmentation size may be the size of a maximum transmission unit (MTU) which depends on an interface type of the network to which each terminal is connected. When address information identical to the destination address information of the generated packet is stored, the packet fragmentation size may be a size given by subtracting the set size of the field added by the gateway from the packet fragmentation size when the address information identical to the destination address information of the generated packet is not stored.

A second aspect of the present invention provides a secure communication system including at least one terminal, the system comprising: at least one virtual private network (VPN) gateway for managing tunnel information of other VPN gateways which are connected via tunnels for secure communication, and for transmitting the tunnel information to each terminal connected via a secure network. When a packet received from the terminal is destined for the secure network, the VPN gateway encrypts the packet, adds a tunnel header to the packet, and transmits the resultant packet to the corresponding tunnel. At least one terminal stores the address information received from the gateway, fragments a generated packet into one of different set sizes according to whether address information identical to destination address information of the packet is stored, and transmits the fragmented packets to the gateway connected to the corresponding secure network. Here, the tunnel information may be IP address information of the VPN gateway which is connected to the tunnel according to IPsec for secure communication.

Each VPN gateway may comprise: a tunnel information manager for managing the tunnel information and for transmitting it to the terminals connected via the secure network; a tunnel information storage unit for storing the tunnel information; and a packet processor for encrypting the packet received from each terminal, for adding the tunnel header to the packet, and for transmitting the resultant packet to the tunnel when the packet is destined for the secure network.

When the tunnel information is added/updated/deleted, the tunnel information manager may update the tunnel information stored in the tunnel information storage unit and transmit the updated tunnel information to the terminals connected via the secure network in real time.

Each terminal may comprise: an information receiver for receiving the tunnel information from the VPN gateway connected to the secure network; a storage unit for storing the tunnel information received via the information receiver; a packet generator for generating the packet according to the type of an application; and a packet fragmenter for fragmenting the packet generated by the packet generator into one of different set packet fragmentation sizes according to whether tunnel information identical to destination address information of the packet is stored in the storage unit, and for transmitting the fragmented packets to the gateway.

When the tunnel information identical to the destination address information of the generated packet is not stored, the packet fragmentation size may be the size of a maximum transmission unit (MTU) which depends on an interface type of a network to which each terminal is connected. When the tunnel information identical to the destination address information of the generated packet is stored, the packet fragmentation size may be a size given by subtracting the size of the tunnel header added by the VPN gateway from the packet fragmentation size when the tunnel information identical to the destination address information of the generated packet is not stored.

In an encapsulating security payload (ESP) mode of IPsec, the tunnel header may comprise at least one of a new IP header field, an ESP header field, an ESP tail field, and an authentication data field, and in an authentication header (AH) mode, the tunnel header may comprise a new IP header field or an AH header field.

The VPN gateway may be disposed in a router for routing the packet.

A third aspect of the present invention provides a secure communication system including at least one terminal, the system comprising: at least one virtual private network (VPN) gateway for transmitting, to each terminal, IP address information of VPN gateways in other secure networks that are connected via tunnels for secure communication, wherein when destination IP address information of a packet received from the terminal is the IP address information of the VPN gateway, the VPN gateway encrypts the packet, adds a tunnel header to the packet, and transmits the resultant packet to the tunnel. The at least one terminal stores the IP address information received from the gateways, and determines whether IP address information identical to destination IP address information of a generated packet is stored, wherein the terminal fragments the packet (a) into a first set size when the IP address information identical to the destination IP address information of the packet is not stored, and (b) into a second size smaller than the first size by the size of an added tunnel when the IP address information identical to the destination IP address information of the packet is stored, and transmits the fragmented packets to the VPN gateway connected to the corresponding secure network.

A fourth aspect of the present invention provides a VPN gateway in a secure communication system, the VPN gateway comprising: a tunnel information manager for managing IP address information of other VPN gateways that are connected via tunnels for secure communication, and for transmitting the IP address information to at least one terminal connected via a secure network; a tunnel information storage unit for storing the IP address information managed by the tunnel information manager; and a packet processor for encrypting a packet received from the terminal, for adding a tunnel header to the packet, and for transmitting the resultant packet to the corresponding tunnel when destination IP address information of the packet is the same as the IP address information of the VPN gateway.

A fifth aspect of the present invention provides a terminal in a secure communication system, the terminal comprising: an information receiver for receiving IP address information of other VPN gateways from a VPN gateway of a corresponding secure network which is connected to the other VPN gateways via tunnels for secure communication; a storage unit for storing the IP address information of the VPN gateways received via the information receiver; a packet generator for generating a packet; and a packet fragmenter for fragmenting the packet generated by the packet generator into the size of an MTU when IP address information identical to destination IP address information of the packet is not stored, and into a size given by subtracting the size of an added tunnel header from the MTU size when the IP address information identical to destination IP address information of the packet is stored, and for transmitting the fragmented packets to the VPN gateway.

A sixth aspect of the present invention provides a method of processing packets in a communication system including at least one gateway and at least one terminal connected to one of the gateways, the method comprising the steps of: managing, by each gateway, at least one address information of a packet to which a field of a set size is added, among destination address information of packets received from each terminal; transmitting, by the gateway, the address information to the connected terminals; storing, by each terminal, the address information, fragmenting the packet into one of different set sizes according to whether address information identical to destination address information of a generated packet is stored, and transmitting the fragmented packets to the gateway; and adding, by the gateway, the field of the set size to the Ipacket and transmitting the resultant packet to a network when the destination address information of the packet received from the terminal is included in the managed address information.

A seventh aspect of the present invention provides a method of processing packets in a secure communication system including at least one VPN gateway and at least one terminal connected to each VPN gateway via a secure network, the method comprising the steps of: managing, by each VPN gateway, tunnel information of other VPN gateways connected via tunnels for secure communication; transmitting, by the VPN gateway, the tunnel information to each terminal when the terminal is connected via the secure network; storing, by each terminal, the tunnel information, fragmenting the packet into one of different set packet fragmentation sizes according to whether tunnel information identical to destination address information of a generated packet is stored, and transmitting the fragmented packets to the gateway; encrypting, by the VPN gateway, the packet received from the terminal, adding a tunnel header to the packet, and transmitting the resultant packet to the tunnel when the destination address information of the packet is the tunnel information of the VPN gateway; and transmitting, by the VPN gateway, the packet received from the terminal to a destination when the destination address information of the packet is not the tunnel information of the VPN gateway.

The step of managing tunnel information may comprise the step of managing, by the VPN gateway, IP address information of the other VPN gateways connected via the tunnels.

When tunnel information identical to destination address information of the packet is not stored, the packet fragmentation size may be the size of a maximum transmission unit (MTU) which depends on the interface type of a network to which each terminal is connected. When tunnel information identical to destination address information of the packet is stored, the packet fragmentation size may be a size obtained by subtracting the size of the tunnel header added by the VPN gateway from the packet fragmentation size when the tunnel information identical to destination address information of the packet is not stored.

When the VPN gateway is in a tunnel mode of the IPsec, the tunnel header may comprise at least one of a new IP header field, an ESP header field, a padding field, a pad length field, a next header field, and an authentication data field.

An eighth aspect of the present invention provides a method of processing packets in a secure communication system including at least one VPN gateway and at least one terminal connected to each VPN gateway via a secure network, the method comprising the steps of: managing, by each VPN gateway, IP address information of other VPN gateways connected via tunnels for secure communication; transmitting, by the VPN gateway, the IP address information to each terminal when the terminal is connected via the secure network; storing, by each terminal, the IP address information and determining whether IP information identical to destination IP address information of a generated packet is stored, wherein when IP information identical to the destination IP address information of the generated packet is not stored, the terminal fragments the packet into a first set size, and when IP information identical to the destination IP address information of the generated packet is stored, the terminal fragments the packet into a second size smaller than the first size by the size of an added tunnel header, and transmits the fragmented packets to the VPN gateway connected to a corresponding secure network; encrypting, by the VPN gateway, each packet received from the terminal, adding the tunnel header to the packet, transmitting the resultant packet to the corresponding tunnel when the destination IP address information of the packet is the IP information of the VPN gateway; and transmitting, by the VPN gateway, the packet to a destination when the destination IP address information of the packet is not the IP information of the VPN gateway.

A ninth aspect of the present invention provides a method of processing packets in a VPN gateway of a secure communication system, comprising the steps of: managing IP address information of other VPN gateways which are connected via tunnels for secure communication; transmitting the IP address information to at least one terminal connected via a secure network; and encrypting a packet received from each terminal, adding a tunnel header to the packet, and transmitting the resultant packet to the corresponding tunnel when destination IP address information of the packet is the same as the IP address information of the VPN gateway.

A tenth aspect of the present invention provides a method of processing packets in a terminal of a secure communication system, comprising the steps of: receiving IP address information of other VPN gateways from a VPN gateway of a corresponding secure network which is connected to the other VPN gateways via tunnels for secure communication, and storing the IP address information; and fragmenting a generated packet into the size of an MTU when IP address information identical to destination IP address information of the packet is not stored, and into a size given by subtracting the size of an added tunnel header from the MTU size when IP address information identical to destination IP address information of the packet is stored, and transmitting the fragmented packets to the VPN gateway.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 illustrates a network connection in a secure communication system according to an exemplary embodiment of the present invention;

FIG. 2 is a block diagram illustrating a terminal and a virtual private network (VPN) gateway according to an exemplary embodiment of the present invention;

FIG. 3A illustrates a process in which a VPN gateway processes a packet in an authentication header (AH) mode;

FIG. 3B illustrates a process in which a VPN gateway processes a packet in an encapsulating security payload (ESP) mode;

FIG. 4A schematically illustrates packet transmission flow in a typical secure communication system;

FIG. 4B illustrates a process in which a packet is re-fragmented in a VPN gateway;

FIG. 5 schematically illustrates packet transmission flow in a secure communication system according to an exemplary embodiment of the present invention;

FIG. 6 is a flowchart illustrating a method of processing packets in a secure communication system according to an exemplary embodiment of the present invention; and

FIG. 7 illustrates the number of packets transmitted to a tunnel in a secure communication system according to the present invention.

### DETAILED DESCRIPTION OF THE INVENTION

Hereinafter, exemplary embodiments of the present invention will be described in detail with reference to the accompanying drawings. For the sake of clarity and conciseness, matters related to the invention that are well known in the art will not be described.

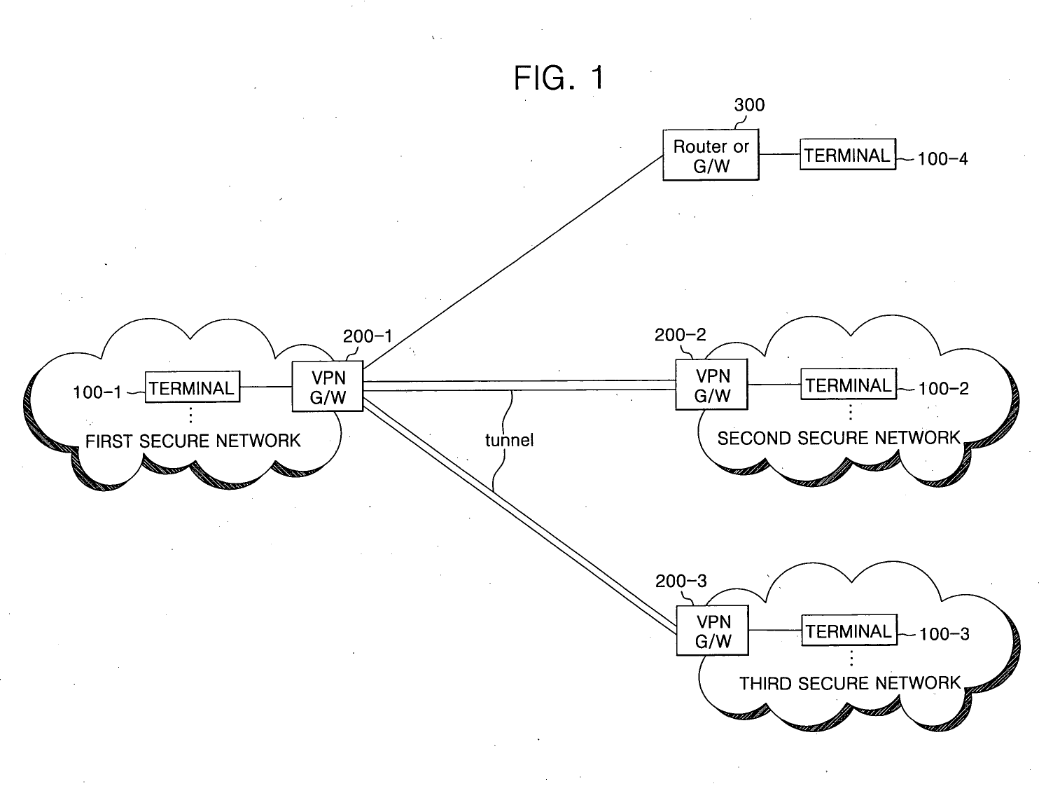

FIG. 1 illustrates a network connection in a secure communication system according to an exemplary embodiment of the present invention.

Referring to FIG. 1, a number of secure networks, each built by a virtual private network (VPN), are interconnected via tunnels according to a tunnel mode of IPsec, and a number of terminals (e.g., terminal 100-1) in each secure network are connected to a VPN gateway (e.g., VPN gateway 200-1) located at a boundary between the secure network and a general network.

Each VPN gateway (e.g., VPN gateway 200-1) is connected to the tunnels through security negotiation according to the IPsec, and manages tunnel information of the correspondent VPN gateways (e.g., VPN gateways 200-2, 200-3) connected via the tunnels. Here, the tunnel information may include IP address information of the VPN gateways 200-2, 200-3.

The VPN gateway 200-1 may be disposed in a router (not shown) located in the boundary between the secure network and the general network. When a packet received from the terminal 100-1 in the secure network is destined for another secure network, the VPN gateway 200-1 encrypts the packet, adds a tunnel header to the packet, and transmits the resultant packet to the other secure network via the tunnel.

The VPN gateway 200-1, 200-2 or 200-3 manages the tunnel information of the other VPN gateways 200-1, 200-2 and 200-3 connected via the tunnel, and transmits the tunnel information to the respective terminals 100-1, 100-2 and 100-3 in the internal secure network.

When the tunnel information is updated/deleted, the VPN gateway 200-1, 200-2 or 200-3 transmits the updated/deleted tunnel information to the respective terminals 100-1, 100-2 and/or 100-3 in the internal secure network in real time.

The terminal 100-1, 100-2 or 100-3 compares destination address information of a generated packet with the tunnel information to determine a packet fragmentation size according to the type of an application.

The terminal 100-1, 100-2 or 100-3 fragments the packet into the determined fragmentation size, and transmits the fragmented packets to the VPN gateway 200-1, 200-2 or 200-3. The VPN gateway 200-1, 200-2 or 200-3 encrypts the packets, adds a tunnel header to the packets, and transmits the resultant packets to the VPN gateway 200-1, 200-2 or 200-3 of the destination secure network.

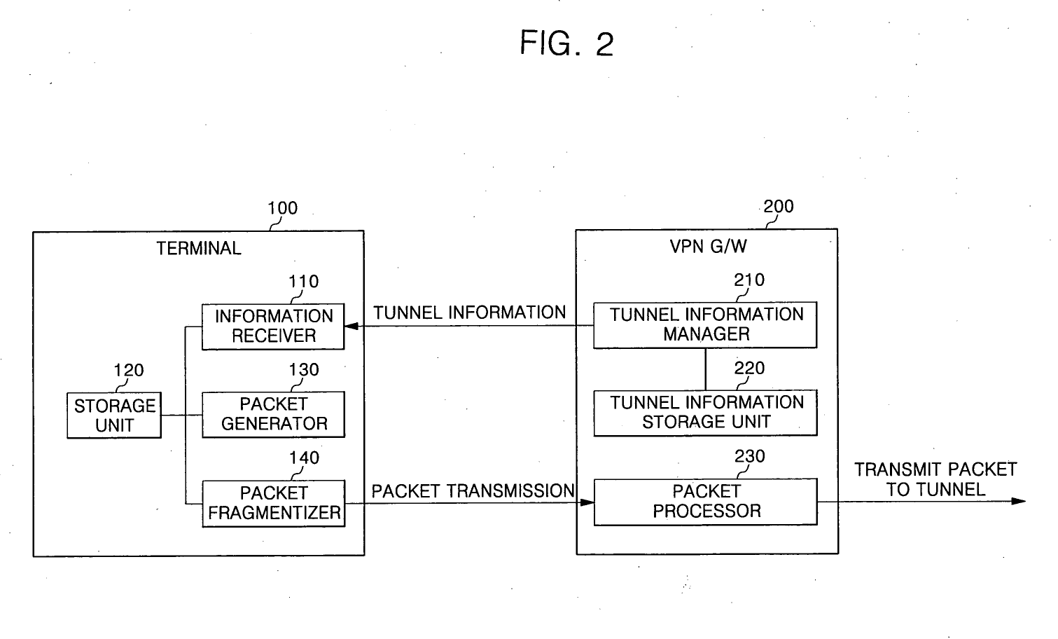

FIG. 2 is a block diagram illustrating a terminal and a VPN gateway according to an exemplary embodiment of the present invention.

Referring to FIG. 2, the terminal 100 according to the present invention includes an information receiver 110, a packet generator 130, a packet fragmenter 140, and a storage unit 120. In addition, the VPN gateway 200 includes a packet processor 230, a tunnel information manager 210, and a tunnel information storage unit 220.

The tunnel information manager 210 of the VPN gateway 200 stores, in the tunnel information storage unit 220, tunnel information, e.g., IP address information, of the VPN gateways 200 in the other secure networks connected via the tunnels through security negotiation according to the IPsec, and transmits the stored tunnel information to the respective terminals 100 in the internal secure network.

When there is a VPN gateway 200 connected via a new tunnel, the tunnel information manager 210 updates the tunnel information stored in the tunnel information storage unit 220, and transmits the updated tunnel information to the respective terminals 100 in real time.

When any of the tunnels is released, the tunnel information manager 210 deletes corresponding tunnel information stored in the tunnel information storage unit 220, and transmits the updated tunnel information to the terminals 100.

When a packet received from the terminal 100 is destined for another secure network, the packet processor 230 encrypts the packet, adds a tunnel header to the packet, and transmits the resultant packet to the destination VPN gateway 200 via the tunnel.

The IPsec includes an encapsulating security payload (ESP) mode and an authentication header (AH) mode.

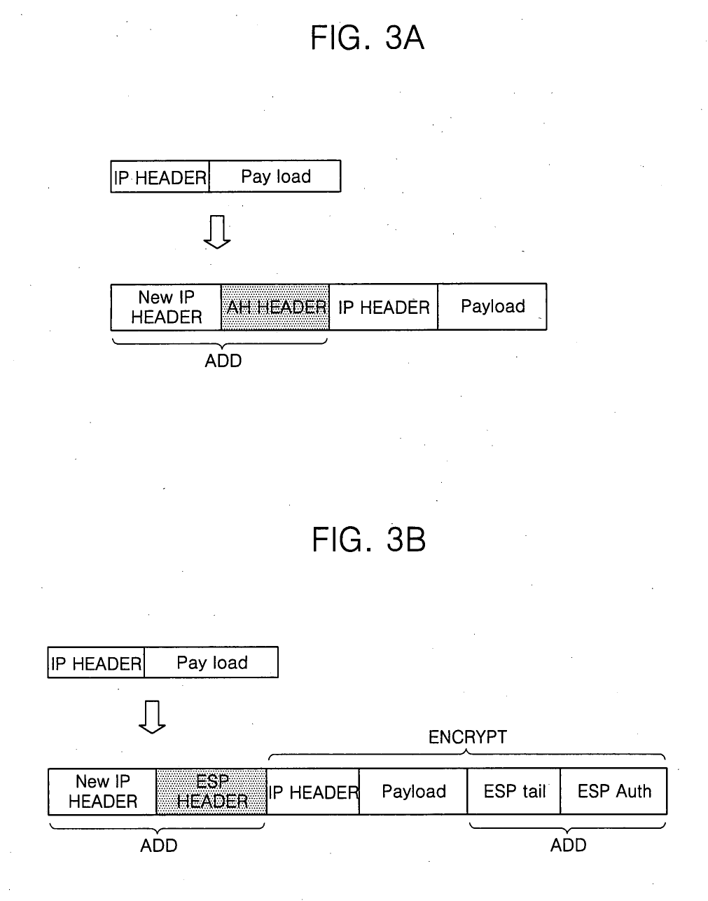

FIG. 3A illustrates a process in which a VPN gateway processes a packet in an authentication header (AH) mode, and FIG. 3B illustrates a process in which a VPN gateway processes a packet in an encapsulating security payload (ESP) mode.

In the AH mode, the VPN gateway 200 adds a new IP header field and an AH header field before an IP header field of a packet received from the terminal 100, and transmits the resultant packet to a destination via the tunnel, as shown in FIG. 3A.

In the ESP mode, the VPN gateway 200 encrypts an IP header field and a payload field of the packet received from the terminal 10, adds a new IP header field and an ESP header field before the IP header field, adds an ESP tail field and an ESP authentication data field (ESP Auth) after the payload field, and transmits the resultant packet to the tunnel, as shown in FIG. 3B.

Here, in the ESP mode, the new IP header field, ESP header field, ESP tail field, and ESP authentication data field (ESP Auth) added by the VPN gateway 200 may correspond to the tunnel header. In addition, in the AH mode, the new IP header and the AH header may correspond to the tunnel header.

Meanwhile, the information receiver 110 of the terminal 100 receives the tunnel information from the VPN gateway 200 and stores them in the storage unit 120.

The packet generator 130 generates a packet according to the type of an application.

The packet fragmenter 140 compares destination IP address information of the packet generated by the packet generator 130 with the tunnel information stored in the storage unit 120 to determine the packet fragmentation size.

Since the tunnel information stored in the storage unit 120 is the IP address information of each VPN gateway 200, the packet fragmenter 140 determines whether the IP address information identical to the destination IP address information of the generated packet is stored in the storage unit 120.

When IP address information identical to the destination IP address information of the packet is not stored in the storage unit 120, the packet fragmenter 140 fragments the generated packet into a fragmentation size (hereinafter, a first fragmentation size; e.g., 1500 bytes) set according to interface type (e.g., Ethernet or asynchronous transfer mode (ATM) of the network), and transmits the fragmented packets to the VPN gateway 200.

Since the destination IP address information of the packet is not the IP address information of the VPN gateway 200, the VPN gateway 200 transmits the fragmented packets to the destination.

When IP address information identical to the destination IP address information of the packet is stored in the storage unit 120, the packet fragmenter 140 fragments the packet into a second fragmentation size smaller than the first fragmentation size, and transmits the fragmented packets to the VPN gateway 200.

In this case, the second fragmentation size may be a value obtained by subtracting the size of the tunnel header added by the VPN gateway 200 from the first fragmentation size. For example, when the MTU size which depends on an interface type of a network connected to the terminal 100 (i.e., the first fragmentation size) is 1500 bytes and the size of the tunnel header added at the VPN gateway 200 is 70 bytes, the second fragmentation size is 1430 bytes.

Since the destination IP address information of the packet is the IP address information of the VPN gateway 200, the VPN gateway 200 encrypts the packet, adds the tunnel header to the packet, and transmits the resultant packet to the tunnel.

Preferably, when the size of the generated packet is greater than the MTU size, the packet fragmenter 140 compares the destination IP address information with the tunnel information. When the size of the generated packet is smaller than the MTU size, the packet fragmenter 140 immediately transmits the packet to the VPN gateway 200.

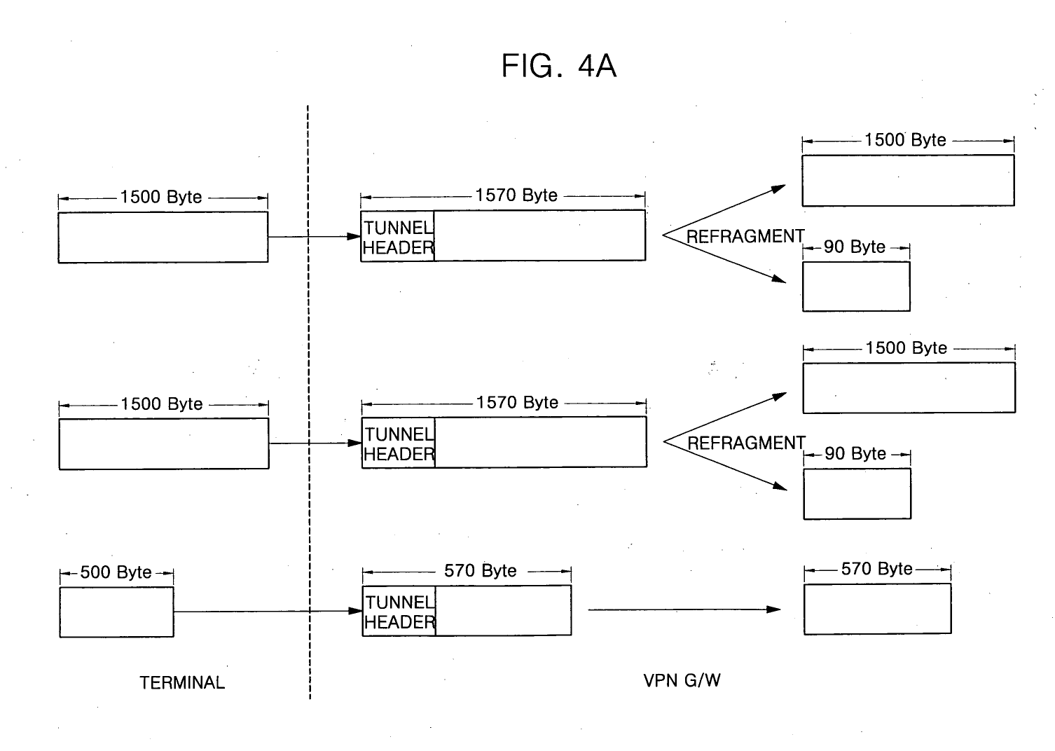

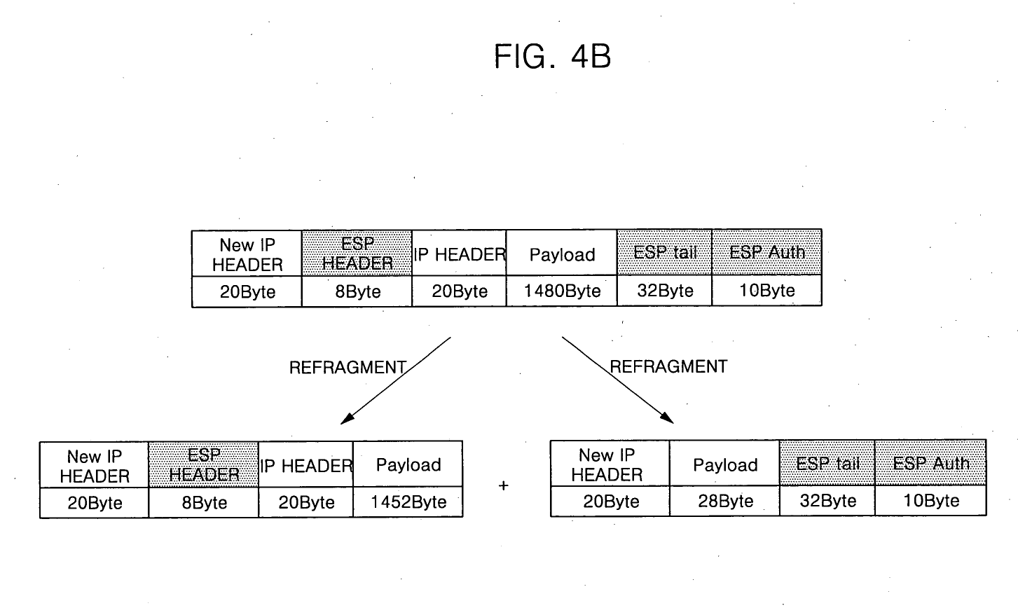

FIG. 4A schematically illustrates packet transmission flow in a typical secure communication system, and FIG. 4B illustrates a process in which a packet is re-fragmented in a VPN gateway.

Referring to FIG. 4A, in a typical secure communication system, a terminal 100, when generating a packet having a size greater than the first fragmentation size, fragments the packet according to the first fragmentation size and transmits the fragmented packets to the VPN gateway 200.

The VPN gateway 200 encrypts the received packets and adds the tunnel header to the packets.

For example, in the ESP mode, the terminal 100 fragments the packet into a size of 1500 bytes and transmits the fragmented packets to the VPN gateway 200 which encrypts the packets and adds a tunnel header of 70 bytes to the packets. Thus, the size of each packet becomes 1570 bytes. The new IP header field and the ESP header field of such a tunnel header are added before the front end of the encrypted packet, and the ESP tail field and the ESP authentication data field are added after the rear end thereof.

Since the size of the packet with the added tunnel header exceeds the MTU size (i.e., 1500 bytes), the VPN gateway 200 re-fragments the packet, as shown in FIG. 4B.

That is, the VPN gateway 200 re-fragments the 1570-byte packet, which is made larger than the MTU due to the added tunnel header, into a 1500-byte packet and a 70-byte packet.

Accordingly, the number of packets transmitted from the terminal 100 to the VPN gateway 200 is equal to the size (P_size) of the generated packet divided by the MTU size (P_size/1500=N). When a remainder is created, the number is N+1.

The number of packets transmitted from the VPN gateway 200 to the tunnel is 2*N+1. Thus, the number of packets transmitted to the tunnel becomes at least two times greater than the number of packets transmitted from the terminal 100.

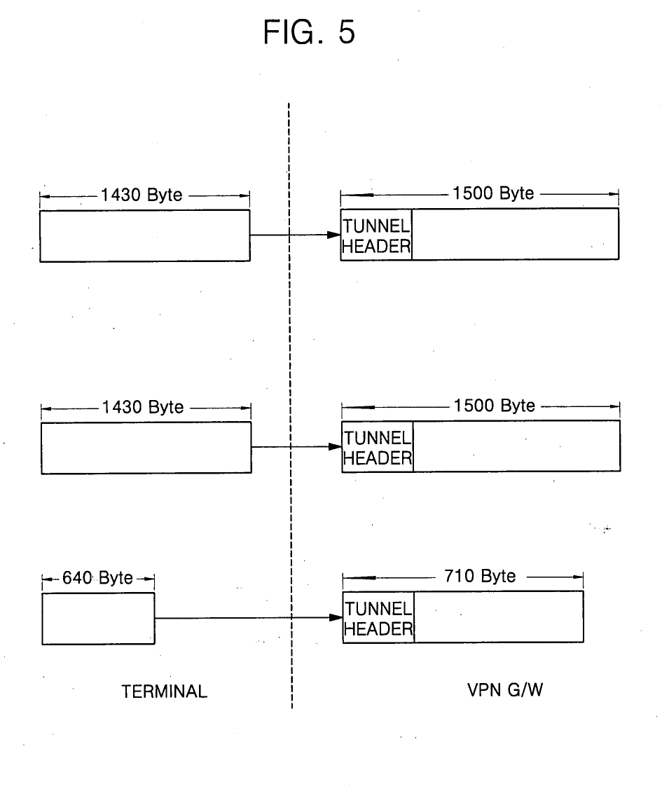

FIG. 5 schematically illustrates packet transmission flow in a secure communication system according to an exemplary embodiment of the present invention.

Referring to FIG. 5, when a packet having a size greater than the first fragmentation size is generated, the terminal 100 of the secure communication system according to the present invention fragments the packet into a second fragmentation size smaller than the first fragmentation size and transmits the fragmented packets to the VPN gateway 200.

The VPN gateway 200 encrypts the fragmented packets, adds the tunnel header to the packets, and transmits the resultant packets to the tunnel.

For example, when the terminal 100 fragments the packet into the size of 1430 bytes and transmits the resultant packets to the VPN gateway 200 which encrypts the packets and adds the tunnel header of 70 bytes to the packets, the size of each packet becomes 1500 bytes.

In this case, the packet is not re-fragmented at the VPN gateway 200. Accordingly, the number of packets transmitted via the tunnel becomes N+1, which is the number of packets transmitted from the terminal 100 to the VPM gateway 200.

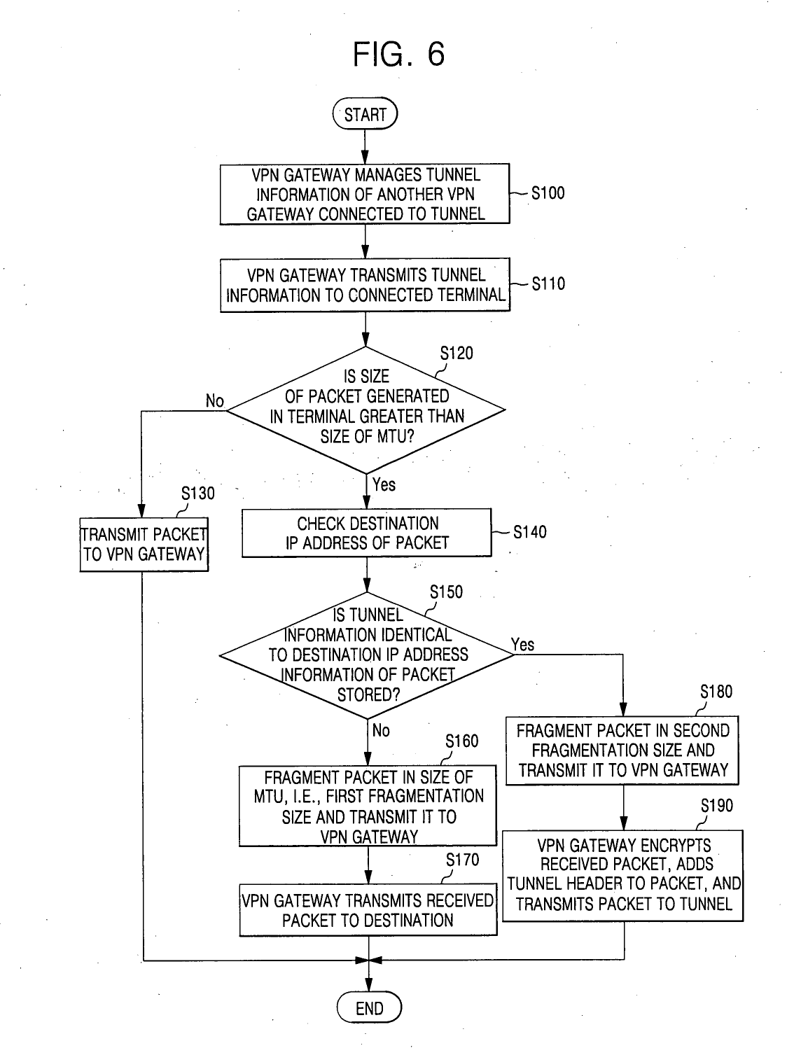

FIG. 6 is a flowchart illustrating a method of processing packets in a secure communication system according to an exemplary embodiment of the present invention.

Referring to FIG. 6, the VPN gateway 200 manages tunnel information of other VPN gateways 200 connected via the tunnels through security negotiation according to the IPsec (S100).

The tunnel information managed by the VPN gateway 200 may be IP address information of the other VPN gateways 200 connected via the tunnels.

When the terminal 100 is connected to the secure network, the VPN gateway 200 transmits the managed tunnel information to the terminal (S110). The terminal 100 receives the tunnel information from the VPN gateway 200 and stores it.

When the tunnel information is added/deleted (updated), the VPN gateway 200 transmits the updated tunnel information to the terminal 100 in real time.

The terminal 100 determines whether the size of a packet generated according to the type of an application is greater than the size of the MTU (S120).

When the size of the generated packet is smaller than the MTU size, the terminal 100 transmits the generated packet to the VPN gateway 200 (S130).

When the packet received from the terminal 100 is destined for the secure network, the VPN gateway 200 encrypts the packet, adds the tunnel header to the packet, and transmits the resultant packet to the tunnel. When the packet is not destined for the secure network, the VPN gateway 200 transmits the packet to a destination.

The VPN gateway 200 determines whether a destination IP address of the packet is an IP address of the other VPN gateway 200 and the packet is destined for the secure network.

Meanwhile, when the packet size is greater than the MTU size (S120), the terminal 100 checks the destination IP address information of the packet (S1140).

The terminal 100 determines whether tunnel information identical to the destination IP address information of the packet (i.e., IP address information of the VPN gateway 200) is stored (S150).

When the IP address information identical to the destination IP address information of the packet is not stored (i.e., when the packet is not destined for the secure network), the terminal 100 fragments the packet into the MTU size (i.e., the first fragmentation size) and transmits the fragmented packets to the VPN gateway 200 (S160).

The VPN gateway 200 transmits the received packet to the destination by referring to the destination IP address of the packet (SI 70).

When IP address information identical to the destination IP address information of the packet is stored (i.e., when the packet is destined for the secure network), the terminal 100 fragments the packet into a second fragmentation size smaller than the MTU size (i.e., the first fragmentation size) and transmits the fragmented packets to the VPN gateway 200 (S180).

The second fragmentation size is equal to a size obtained by subtracting the size of the tunnel header added by the VPN gateway 200 encrypting the packet from the first fragmentation size.

The VPN gateway 200 encrypts the packets received from the terminal 100, adds the tunnel header to the packets, and transmits the resultant packets to the destination (i.e., the VPN gateway 200 of the secure network) via the tunnel (SI 90).

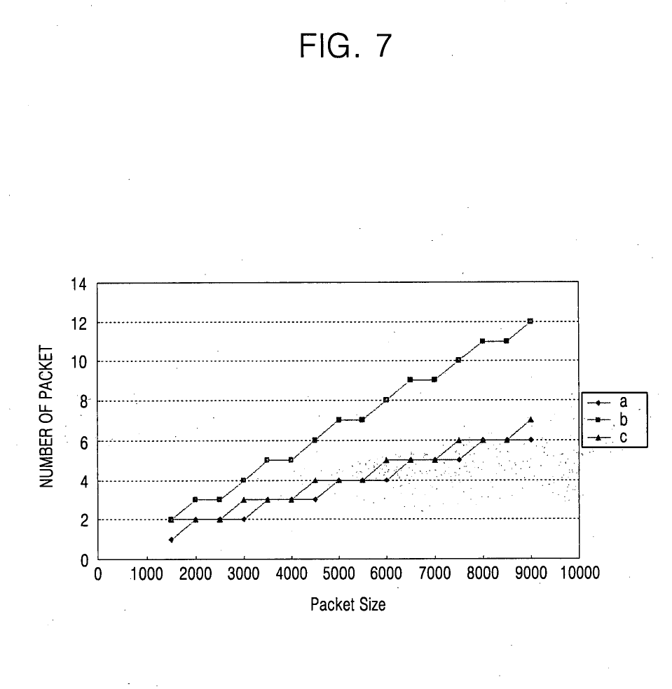

FIG. 7 illustrates the number of packets transmitted via a tunnel in a secure communication system according to the present invention.

Referring to FIG. 7, as the size of the packet generated by the terminal 100 increases the number (a) of fragmented and transmitted packets increases.

When, in a typical secure communication system, the terminal 100 fragments a packet into the size of the MTU and transmits the fragmented packets to the VPN gateway 200, the number (b) of the packets transmitted to the tunnel is about two times greater than the number (a) of the packets transmitted by the terminal 100 as the VPN gateway 200 adds the tunnel header.

However, in the secure communication system according to the present invention, when the terminal 100 fragments a packet into the MTU size minus the tunnel header size and transmits the fragmented packets to the VPN gateway 200, a number (c) of packets, equal to the number (a) of packets transmitted from the terminal 100, are transmitted to the tunnel.

While the present invention has been described by way of example in connection with the VPN gateway encrypting the packet and adding the tunnel header to the packet, it may be equally applied to a VoIP-based SIP server adding and deleting the content of a message.

As described above, according to the present invention, when the packet size is changed in the network, the packet fragmentation size is adjusted in consideration of the increased size, thus preventing the number of packets in the network from increasing geometrically and, in turn, maximizing use of the network.

While the present invention has been described with reference to exemplary embodiments thereof, it will be understood by those skilled in the art that various changes in form and detail may be made therein without departing from the scope of the present invention as defined by the following claims.

What is claimed is:

1. A communication system including at least one terminal, the system comprising:
a gateway for managing at least one destination address information of a packet to which a field of a set size is added, among destination address information of packets received from each terminal, and for transmitting the address information to each said at least one terminal, wherein when the destination address information of the packet received from each said at least one terminal exists in the managed address information, the gateway adds the field of the set size to the packet and transmits the resultant packet to a network; and
said at least one terminal storing the address information received from the gateway, fragmenting the packet into one of different set packet fragmentation sizes according to whether address information identical to the destination address information of the generated packet is stored, and transmitting the fragmented packets to the gateway.

2. The system of claim 1, wherein the field of the set size is a tunnel header required for the gateway to transmit the packet via a tunnel according to IPsec.

3. The system of claim 1, wherein when the address information identical to the destination address information of the generated packet is not stored, the packet fragmentation size is the size of a maximum transmission unit (MTU) which depends on an interface type of the network to which each terminal is connected.

4. The system of claim 1, wherein when the address information identical to the destination address information of the generated packet is stored, the packet fragmentation size is a size obtained by subtracting the set size of the field added by the gateway from the packet fragmentation size when the address information identical to the destination address information of the generated packet is not stored.

5. A secure communication system including at least one terminal, the system comprising:
at least one virtual private network (VPN) gateway for managing tunnel information of other VPN gateways that are connected via tunnels for secure communication, and transmitting the tunnel information to each said at least one terminal connected via a secure network, wherein when a packet received from the terminal is destined for the secure network, the VPN gateway encrypts the packet, adds a tunnel header to the packet, and transmits the resultant packet to the corresponding tunnel;
said at least one terminal storing the address information received from the gateway, fragmenting a generated packet into one of different set sizes according to whether address information identical to destination address information of the packet is stored, and transmitting the fragmented packets to the gateway connected to the corresponding secure network.

6. The system of claim 5, wherein the tunnel information is IP address information of the VPN gateway that is connected to the tunnel according to IPsec for secure communication.

7. The system of claim 5, wherein each VPN gateway comprises:
a tunnel information manager for managing the tunnel information and for transmitting it to the terminals connected via the secure network;
a tunnel information storage unit for storing the tunnel information; and
a packet processor for encrypting the packet received from each said at least one terminal, for adding the tunnel header to the packet, and for transmitting the resultant packet to the tunnel when the packet is destined for the secure network.

8. The system of claim 7, wherein when the tunnel information is added/deleted, the tunnel information manager updates the tunnel information stored in the tunnel information storage unit and transmits the updated tunnel information to the terminals connected via the secure network in real time.

9. The system of claim 5, wherein each said at least one terminal comprises:
an information receiver for receiving the tunnel information from the VPN gateway connected to the secure network;
a storage unit for storing the tunnel information received via the information receiver;
a packet generator for generating the packet according to a type of an application; and
a packet fragmenter for fragmenting the packet generated by the packet generator into one of different set packet fragmentation sizes according to whether tunnel information identical to destination address information of the packet is stored in the storage unit, and for transmitting the fragmented packets to the gateway.

10. The system of claim 5, wherein when tunnel information identical to the destination address information of the generated packet is not stored, the packet fragmentation size is the size of a maximum transmission unit (MTU) which depends on an interface type of a network to which each said at least one terminal is connected.

11. The system of claim 5, wherein when tunnel information identical to the destination address information of the generated packet is stored, the packet fragmentation size is a size obtained by subtracting the size of the tunnel header added by the VPN gateway from the packet fragmentation size when the tunnel information identical to the destination address information of the generated packet is not stored.

12. The system of claim 5, wherein in an encapsulating security payload (ESP) mode of IPsec, the tunnel header comprises at least one of a new IP header field, an ESP header field, an ESP tail field, and an authentication data field, and in an authentication header (AH) mode, the tunnel header comprises a new IP header field or an AH header field.

13. A secure communication system including at least one terminal, the system comprising:
at least one virtual private network (VPN) gateway for transmitting, to each said at least one terminal, IP address information of VPN gateways in other secure networks that are connected via tunnels for secure communication, wherein when destination IP address information of a packet received from said at least one terminal is the IP address information of said at least one VPN gateway, said at least one VPN gateway encrypts the packet, adds a tunnel header to the packet, and transmits the resultant packet to the tunnel;
said at least one terminal storing the IP address information received from the gateways, and determining whether IP address information identical to destination IP address information of a generated packet is stored, wherein said at least one terminal fragments the packet (a) into a first set size when IP address information identical to the destination IP address information of the packet is not stored, and (b) into a second size smaller than the first size by the size of an added tunnel when the IP address information identical to the destination IP address information of the packet is stored, and transmits the fragmented packets to said at least one VPN gateway connected to the corresponding secure network.

14. A VPN gateway in a secure communication system, the VPN gateway comprising:
a tunnel information manager for managing IP address information of other VPN gateways that are connected via tunnels for secure communication, and for transmitting the IP address information to at least one terminal connected via a secure network;
a tunnel information storage unit for storing the IP address information managed by the tunnel information manager; and
a packet processor for encrypting a packet received from said at least one terminal, for adding a tunnel header to the packet, and for transmitting the resultant packet to the corresponding tunnel when destination IP address information of the packet is the same as the IP address information of the VPN gateway.

15. A terminal in a secure communication system, the terminal comprising:
an information receiver for receiving IP address information of other VPN gateways from a VPN gateway of a corresponding secure network that is connected to the other VPN gateways via tunnels for secure communication;
a storage unit for storing the IP address information of the VPN gateways received via the information receiver;
a packet generator for generating a packet; and
a packet fragmenter for fragmenting the packet generated by the packet generator into the size of an MTU when IP address information identical to destination IP address information of the packet is not stored, and into a size obtained by subtracting the size of an added tunnel header from the MTU size when the IP address information identical to destination IP address information of the packet is stored, and transmitting the fragmented packets to the VPN gateway.

16. A method of processing packets in a communication system including at least one gateway and at least one terminal connected to one of the gateways, the method comprising the steps of:
managing, by each said at least one gateway, at least one address information of a packet to which a field of a set size is added, among destination address information of packets received from each said at least one terminal;
transmitting, by said at least one gateway, the address information to connected terminals;
storing, by each said at least one terminal, the address information, fragmenting the packet into one of different set sizes according to whether address information identical to destination address information of a generated packet is stored, and transmitting the fragmented packets to said at least one gateway; and
adding, by said at least one gateway, the field of the set size to the packet and transmitting the resultant packet to a network when the destination address information of the packet received from said at least one terminal is included in the managed address information.

17. A method of processing packets in a secure communication system including at least one VPN gateway and at least one terminal connected to each said at least one VPN gateway via a secure network, the method comprising the steps of:
managing, by each said at least one VPN gateway, tunnel information of other VPN gateways connected via tunnels for secure communication;
transmitting, by said at least one VPN gateway, the tunnel information to each said at least one terminal when said at least one terminal is connected via the secure network;
storing, by each said at least one terminal, the tunnel information, fragmenting the packet into one of different set packet fragmentation sizes according to whether tunnel information identical to destination address information of a generated packet is stored, and transmitting the fragmented packets to said at least one gateway;
encrypting, by said at least one VPN gateway, the packet received from said at least one terminal, adding a tunnel header to the packet, and transmitting the resultant packet to the tunnel when the destination address information of the packet is the tunnel information of said at least one VPN gateway; and
transmitting, by said at least one VPN gateway, the packet received from said at least one terminal to a destination when the destination address information of the packet is not the tunnel information of said at least one VPN gateway.

18. The method of claim 17, wherein the step of managing tunnel information comprises managing, by said at least one VPN gateway, IP address information of the other VPN gateways connected via the tunnels.

19. The method of claim 17, wherein when tunnel information identical to destination address information of the packet is not stored, the packet fragmentation size is a size of a maximum transmission unit (MTU) which depends on an interface type of a network to which each said at least one terminal is connected.

20. The method of claim 17, wherein when tunnel information identical to destination address information of the packet is stored, the packet fragmentation size is a size obtained by subtracting the size of the tunnel header added by said at least one VPN gateway from the packet fragmentation size when the tunnel information identical to destination address information of the packet is not stored.

21. The method of claim 17, wherein when said at least one VPN gateway is in a tunnel mode of the IPsec, the tunnel header comprises at least one of a new IP header field, an ESP header field, a padding field, a pad length field, a next header field, and an authentication data field.

22. A method of processing packets in a secure communication system including at least one VPN gateway and at least one terminal connected to each said at least one VPN gateway via a secure network, the method comprising the steps of:
managing, by each said at least one VPN gateway, IP address information of other VPN gateways connected via tunnels for secure communication;
transmitting, by said at least one VPN gateway, the IP address information to each said at least one terminal when said at least one terminal is connected via the secure network;
storing, by each said at least one terminal, the IP address information and determining whether IP information identical to destination IP address information of a generated packet is stored, wherein when IP information identical to the destination IP address information of the generated packet is not stored, said at least one terminal fragments the packet into a first set size, and when IP information identical to the destination IP address information of the generated packet is stored, said at least one terminal fragments the packet into a second size smaller than the first size by the size of an added tunnel header, and transmits the fragmented packets to said at least one VPN gateway connected to a corresponding secure network;
encrypting, by said at least one VPN gateway, each packet received from said at least one terminal, adding the tunnel header to the packet, transmitting the resultant packet to the corresponding tunnel when the destination IP address information of the packet is the IP information of said at least one VPN gateway; and
transmitting, by said at least one VPN gateway, the packet to a destination when the destination IP address information of the packet is not the IP information of said at least one VPN gateway.

23. A method of processing packets in a VPN gateway of a secure communication system, comprising the steps of:
managing IP address information of other VPN gateways that are connected via tunnels for secure communication;
transmitting the IP address information to at least one terminal connected via a secure network; and
encrypting a packet received from each said at least one terminal, adding a tunnel header to the packet, and transmitting the resultant packet to the corresponding tunnel when destination IP address information of the packet is the same as the IP address information of the VPN gateway.

24. A method of processing packets in a terminal of a secure communication system, comprising the steps of:
receiving IP address information of other VPN gateways from a VPN gateway of a corresponding secure network that is connected to the other VPN gateways via tunnels for secure communication, and storing the IP address information; and
fragmenting a generated packet into a size of an MTU when IP address information identical to destination IP address information of the packet is not stored, and into a size obtained by subtracting a size of an added tunnel header from the MTU size when IP address information identical to destination IP address information of the packet is stored, and transmitting the fragmented packets to the VPN gateway.
